(19) United States
(12) Patent Application Publication
(10) Pub. No.: US 2004/0103099 A1
(43) Pub. Date: May 27, 2004

(54) Inter-network relay storage apparatus and inter-network relay method

(75) Inventor: Kunio Minagawa, Kawasaki (JP)

Correspondence Address: Patrick G. Burns, Esq., GREER, BURNS & CRAIN, LTD., Suite 2500, 300 South Wacker Dr., Chicago, IL, 60606, US

(73) Assignee: FUJITSU LIMITED

(21) Appl. No.: 10/717,043

(22) Filed: Nov. 19, 2003

(30) Foreign Application Priority Data
Nov. 20, 2002 (JP) 2002-337080

(51) Int. Cl. G06F 17/30

(52) U.S. Cl. 707/10

(57) ABSTRACT

A relay storage apparatus executes data relay between separated networks using a storage apparatus and performs exclusive control between systems in an operation equivalent to the case of a network connection. The relay storage apparatus has a storage unit having a data area for storing files to be transferred between the networks in file units, and a file management table for indicating the access status to the file, and data management unit for performing exclusive control between file systems for each one of the networks using the file management table. Since exclusive control is performed in file units, the operation of data distribution between networks becomes easier while insuring the certainty of data distribution, just like the case of a network connection.

### CROSS-REFERENCE TO RELATED APPLICATIONS

This application is based upon and claims the benefit of priority from the prior Japanese Patent Application No. 2002-337080, filed on Nov. 20, 2002, the entire contents of which are incorporated herein by reference.

### BACKGROUND OF THE INVENTION

1. Field of the Invention

The present invention relates to an inter-network relay storage apparatus and an inter-network relay method for distributing data between independent network environments.

2. Description of the Related Art

Data distribution based on network connections is becoming easier because of the advancement of network technologies. For example, data distribution is performed by using a file transfer by FTP (File Transfer Protocol) and a distributed file system by NFS (Network File System) and CIFS (Common Internet File System).

This data distribution method based on network connections, however, has huge security risks. So in some cases, a plurality of independent network environments are constructed. For example, an Internet environment and an intranet environment are constructed, with the intranet as the system inside a company and the Internet as the system outside the company.

In this plurality of independent network environments, access between the networks is disabled, so the intranet environment can be protected from illegal access, and an improper outflow of data and contamination by viruses can be prevented, therefore there is high safety in terms of security.

On the other hand, there is a demand to distribute data with continued security even between these separated independent network environments. For example, data to be disclosed in the Internet environment, from data in the intranet environment, is distributed in the Internet environment.

Prior art for distributing data between a plurality of independent networks will be described with reference to FIG. 9 and FIG. 10. As FIG. 9 shows, the service system 102, disposed in the Internet 100, performs service processing in the Internet environment using the/dedicated storage apparatus 104. An another service system 122 disposed in the intranet 120, on the other hand, performs service processing in the intranet environment using the dedicated storage apparatus 124.

For distribution between the Internet 100 and the intranet 120, a portable medium 110, such as a magnetic tape and a magneto-optical disk, is used. In other words, the data is written to the portable medium in the service system 102 or 122, the portable medium 110 is transported to another service system 122 or 102 to read the data, so as to enable use of the data in another network (e.g. Japanese Patent Application Laid-Open No. 2000-276457).

In the method shown in FIG. 10, a shared disk apparatus 112, which the service system 102 of the Internet 100 and the service system 122 of the intranet 120 can share, is disposed, and the data is distributed by switching the connection of the shared disk apparatus 112 and the service systems 102. and 122 (e.g. Japanese Patent Application Laid-Open No. 2000-276457).

However, the problem of a distribution method using a portable medium is that writing data to the portable medium must be performed each time data is distributed, and the portable medium must be transported and set to another service system, which makes the data distribution operation complicated and also makes automatic distribution difficult.

In an exclusive control method which switches the connection of the shared disk apparatus, it is necessary that pair of servers, which use the shared disk apparatus, are connected with a dedicated line, and the pair of servers performs exclusive control of the shared disk apparatus, and a dedicated application program must be newly installed.

Because of this, data distribution processing for distributing data is complicated and a new application program must be created, and also the load of the service system is high.

### SUMMARY OF THE INVENTION

With the foregoing in view, it is an object of the present invention to provide an inter-network relay storage apparatus and an inter-network relay method for simplifying the operation of data distribution processing while insuring safety in terms of security.

It is another object of the present invention to provide an inter-network relay storage apparatus and an inter-network relay method for enabling the operation of data distribution processing equivalent to the case of a network connection, while insuring safety in terms of security.

It is still another object of the present invention to provide an inter-network relay storage apparatus and an inter-network relay method for simplifying the operation of the data distribution processing between a plurality of service servers of a network and a plurality of service servers of another network, while insuring safety in terms of security.

To achieve these objects, the present invention is an inter-network relay storage apparatus for distributing data between a plurality of independent network environments, comprising a storage unit having a data area for storing files to be transferred between the networks in file units and a file management table to indicate the access status to the file, and data management unit for performing exclusive control between file systems for each one of the networks using the file management table.

The present invention is also an inter-network relay method for distributing data between a plurality of independent network environments, comprising a step of performing the exclusive control between the file system using a file management table to indicate the access status to a file in the storage apparatus, and a step of reading and writing files in file units from/to the storage apparatus during the exclusive control, and relaying data between the networks.

In the present invention, the data relay between separate networks is executed by the exclusive control within the storage apparatus, so data can be distributed easily while insuring safety in terms of security between the separate networks. Therefore by installing the storage apparatus, an operation of data distribution processing equivalent to a network connection becomes possible for each service system of an individual network.

Also exclusive control is performed in file units, so operation between networks becomes easy while insuring the certainty of data distribution. For example, while writing one file, another file can be read.

In the present invention, it is preferable that the data management unit is disposed in a pair of network servers which are connected to said networks respectively, so the present invention can be implemented easily.

In the present invention, it is preferable that the inter-relay storage apparatus further comprises a pair of network connection servers having the data management unit respectively, and is connected to the networks respectively, and communicates data via the networks. Because of this, a relay request can be processed easily by the control of the server.

In the present invention, it is preferable that, when the file of the storage unit is read or written, the data management unit sets an indication to show the file is in use in the file management table before the file is read or written, and resets the in-use indication after the file is read or written to perform the exclusive control. Therefore exclusive control in file units can be easily implemented.

In the present invention, it is preferable that the data area of the storage unit includes a first area which is written by one file system of the plurality of file systems and which is read by another file system, and a second area which is written by the above mentioned other file system and which is read by the above mentioned one file system. Therefore exclusive control of data relay in both directions becomes more certain.

In the present invention, it is preferable that the network connection server includes a network control unit for connecting with the network for communication, and the data management unit. Because of this, each relay request of a plurality of service system in one network can be processed.

### BRIEF DESCRIPTION OF THE DRAWINGS

FIG. 1 is a block diagram depicting the inter-network relay storage apparatus according to an embodiment of the present invention;

FIG. 2 is a diagram depicting the management information of the relay processing in FIG. 1;

FIG. 3 is a flow chart depicting the write processing of the inter-system exclusive control in FIG. 1;

FIG. 4 is a flow chart depicting the read processing of the inter-system exclusive control in FIG. 1;

FIG. 5 is a diagram depicting the data relay processing in FIG. 1;

FIG. 6 is a block diagram depicting the second embodiment of the present invention;

FIG. 7 is a block diagram depicting the third embodiment of the present invention;

FIG. 8 is a block diagram depicting the fourth embodiment of the present invention;

FIG. 9 is a diagram depicting a conventional inter-network relay method; and

FIG. 10 is a diagram depicting another conventional inter-network relay method.

### DESCRIPTION OF THE PREFERRED EMBODIMENTS

Embodiments of the present invention will now be described in the sequence of the inter-network relay storage apparatus, inter-network data relay processing, second embodiment, third embodiment, fourth embodiment and other embodiments, but the present invention is not limited to these embodiments.

[Inter-network Relay Storage Apparatus]

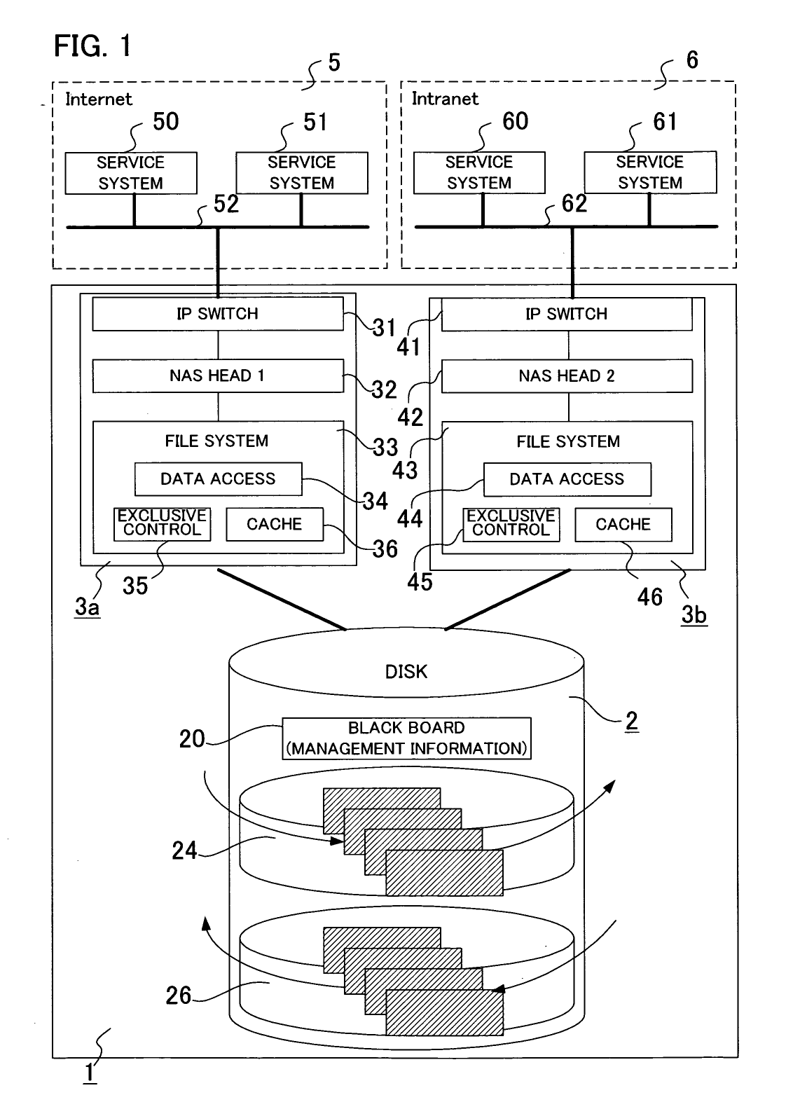

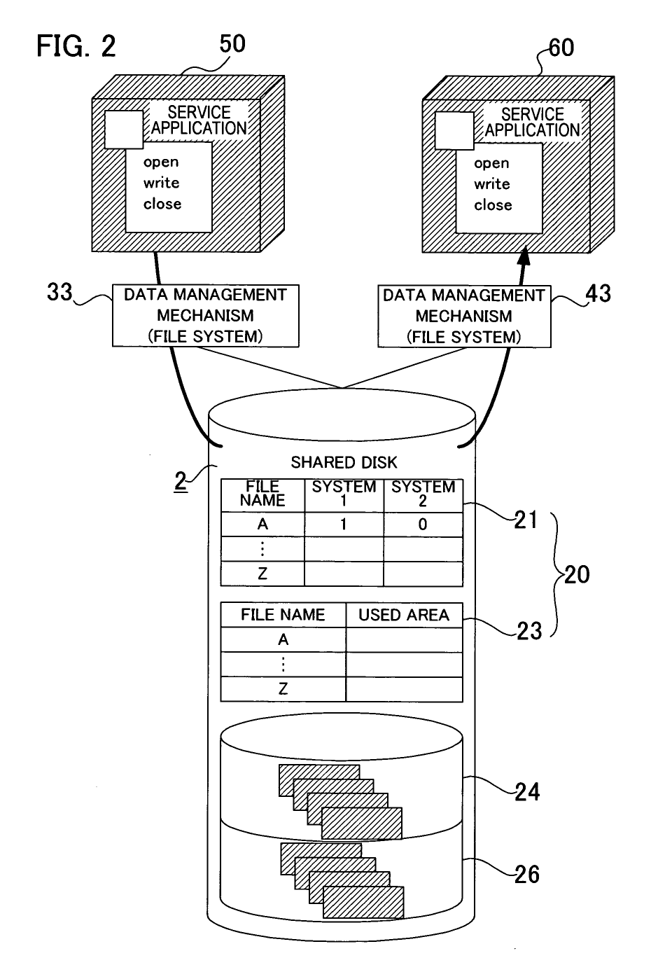

FIG. 1 is a block diagram depicting the entire inter-network relay storage apparatus according to an embodiment of the present invention, and FIG. 2 is a diagram depicting the table in FIG. 1. In FIG. 1, the present invention is described using a network storage server (NSS) as an example.

As FIG. 1 shows, the network storage server, (NSS) 1 is comprised of a disk apparatus (DISK) 2 and a pair of network attached servers (NAS) 3a and 3b.

The NAS 3a is connected to the Internet 5 and the NAS 3b is connected to the intranet 6. The NAS 3a and 3b are respectively connected to the IP (Internet Protocol) switches 31 and 41, NAS heads 32 and 42, and the file systems (programs) 33 and 43. The IP switches 31 and 41 are switches for physically connecting the network 52 of the Internet 5 and the network 62 of the intranet 6 respectively.

The NAS heads 32 and 42 and the file systems (programs) 33 and 43 are implemented by the programs of the processor system in the server. The NAS heads 32 and 42 perform the network connection and interface processing. The file systems 33 and 43 are programs for controlling the file and perform data access processing 34 and 44 using the cache memories 36 and 46.

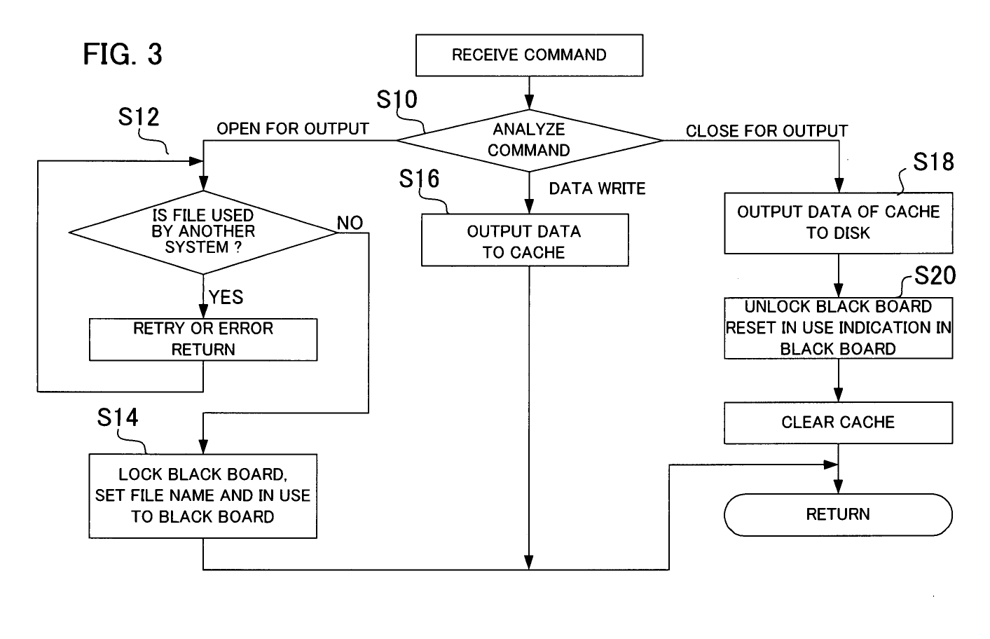

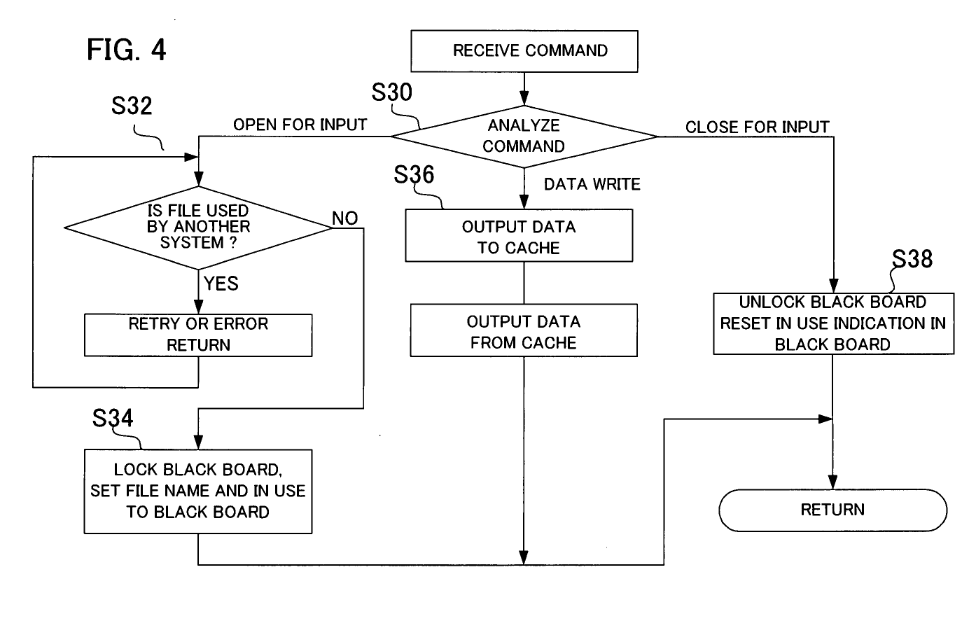

In the present embodiment, the exclusive control processing programs 35 and 45 for performing exclusive control of this data access processing are included in the file systems 33 and 43. These exclusive control processing programs 35 and 45 are for performing the exclusive control of access to the disk apparatus 2 in the later mentioned file units, and will be described later with reference to FIG. 3 and FIG. 4.

The disk apparatus 2 is a shared disk apparatus comprised of the disk controller and the hard disk unit (HDD). In this disk apparatus 2, a management information area (hereafter called blackboard) 20 for transferring management information, a first transfer area 24 for writing of the NAS 3a and reading of the NAS 3b, and a second transfer area 26 for writing of the NAS 3b and reading of the NAS 3a are disposed.

As FIG. 2 shows, the blackboard 20 is comprised of a file use control table 21 and a file management table 23. The file use control table 21 indicates the file system which is using each file to be transferred, and is set to lock (“1”) if in use, and is set to unlock (“0”) if not in use.

The file management table 23 stores the area in use and the capacity of each file to be transferred. The first transfer area 24 stores the files written by the NAS 3a and read by the NAS 3b in file units. The second transfer area 26 stores files written by the NAS 3b and read by the NAS 3a in file units.

In FIG. 1, the Internet 5 has a plurality of service systems 50 and 51 connected to the Internet network 52. The intranet 6 has a plurality of service systems 60 and 61 connected to the intranet 62. Each service system 50, 51, 60 and 61 includes a service server.

As FIG. 2 shows, by including this exclusive control mechanism in a file system, the service application program of the service system 50 and 60 of the independent network can share the disk apparatus 2 and transfer data asynchronously with other service systems.

In other words, as the service systems are not connected to the network, it is possible to insure safety in terms of security and also operate data distribution processing equivalent to the case of a network connection. Also as FIG. 1 shows, by including the exclusive control mechanism in the NAS, data can be transferred between service systems beyond the network, even if a plurality of service systems exists in one network.

[Inter-Network Data Relay Processing]

Now the exclusive control processing 35 and 45, using the above mentioned blackboard in FIG. 1, will be described with reference to FIG. 3 to FIG. 5. FIG. 3 is a flow chart of file write processing. In this example, open and close instructions are used.

(S10) When a command is received from the network, the command is analyzed. This command analysis is performed by the NAS heads 32 and 42.

(S12) When the output system open command is notified from the NAS head, the exclusive control processing program determines whether the corresponding file is being used by another system, referring to the file use control table 21 of the blackboard 20. As described above, the file use control table 21 is for indicating the file system which is using each file to be transferred, and is set to lock (“1”) if in-use, and to unlock,(“0”) if not in use. If the file is in use by another system, a retry or error return status occurs, and the file system waits until the in use status is cleared (until lock is cleared).

(S14) When this file is not being used by another system, the file name and the in use indication “1” are set in the blackboard 20 (more precisely in the table 21) and locked. If this file is a new file, the file name is registered in the file management table, 23 and a use area is secured. And return is executed.

(S16) When the write command is notified from the NAS head, the exclusive control processing program writes data to the cache memories 36 and 46 of the server via data access processing. And return is executed.

(S18) When the output system close command is notified from the NAS head, the exclusive control processing program writes the data of the cache memories 36 and 46 to the area 24 or 26 on the disk specified by the file management table 23.

(S20) After the writing ends, the in use indication of this file name is reset to “0” in the blackboard 20 (more precisely in the table 21), and the blackboard is unlocked. Also the cache memories 36 and 46 are cleared and return is executed.

FIG. 4 is a flow chart depicting file read processing. In this example as well, open and close instructions are used.

(S30) When a command is received from the network, the command is analyzed. This command analysis is performed by the NAS heads 32 and 42.

(S32) When an input system open command is notified from the NAS head, the exclusive control processing program determines whether the corresponding file is being used by another system, referring to the file use control table 21 of the blackboard 20. As described above, the file use control table 21 is for indicating the file system which is using each file to be transferred, and is set to lock (“1”) if in use, and to unlock (“0”) if not in use. If the file is being used by another system, a retry or error return status occurs, and the file system waits until the in use status is cleared (until lock is cleared).

(S34) When this file is not being used by another system, the file name and the in use indication “1” are set in the blackboard 20 (more precisely in the table 21) and locked. And return is executed.

(S36) When the data read command is notified from the NAS head, the exclusive control processing program reads the data of this file from the area 24 or 26 of the disk apparatus 2 to the cache memories 36 and 46 of the server via data access processing. And the data of the cache memories 36 and 46 is transferred to the read destination service system, and return is executed.

(S38) When the input system close command is notified from the NAS head, the in-use indication of this file name is reset to “0” in the blackboard 20 (more precisely in the table 21) and the blackboard is unlocked. Then return is executed.

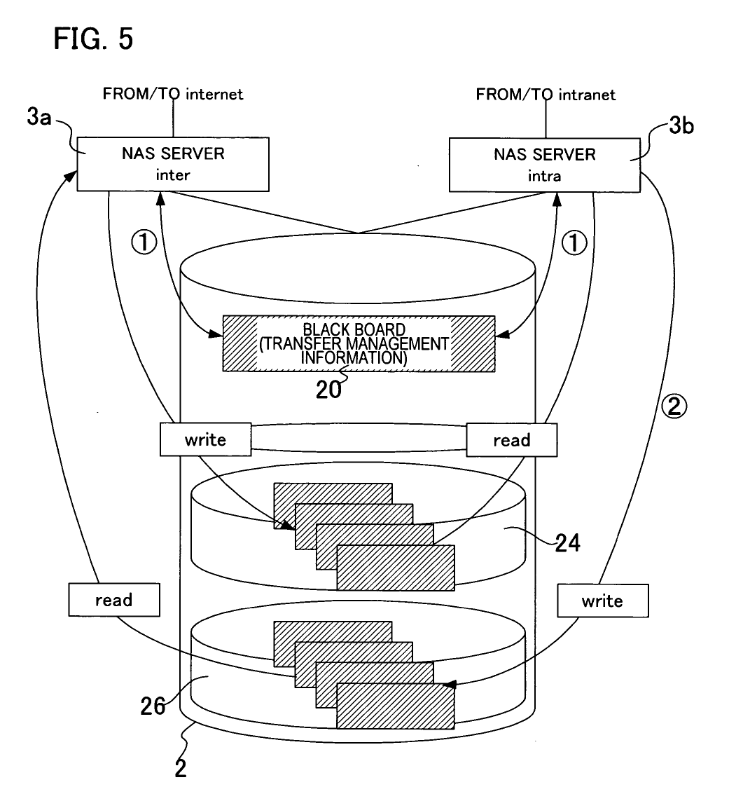

As FIG. 5 shows, [1] the blackboard 20 is locked, and [2] write/read is executed. The lock of the blackboard is not released, and the lock of the blackboard is released after write or read is completed. This makes exclusive control between systems possible and insures the completeness of a data transfer.

Also the area of the disk apparatus is divided and an area is allocated for each file system, so certainty of a data transfer can be insured. Also the exclusive control is performed by the blackboard 20 and the blackboard lock mechanism, which can be implemented easily.

[Second Embodiment]

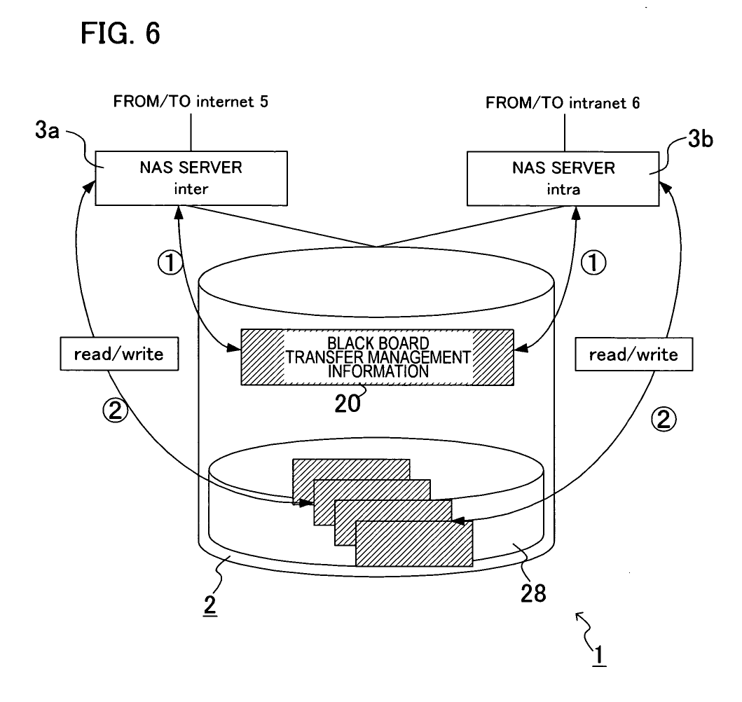

FIG. 6 is a block diagram depicting the second embodiment of the present invention, and shows a variant form of the exclusive control mechanism in FIG. 1. As FIG. 6 shows, just like the embodiment in FIG. 1, the network storage server (NSS) 1 is comprised of the disk apparatus (DISK) 2 and a pair of network attached servers (NAS) 3a and 3b.

The NAS 3a is connected to the Internet 5 and the NAS 3b is connected to the intranet 6. Just like FIG. 1, the NAS 3a and 3b are respectively comprised of the IP (Internet Protocol) switches 31 and 41, NAS heads 32 and 42, and file systems (programs) 33 and 43. The file systems 33 and 43 are programs for controlling a file, and perform data access processing 34 and 44 using the cache memories 36 and 46.

In this embodiment as well, the exclusive control processing programs 35 and 45 for performing exclusive control of this data access processing are included in the file systems 33 and 43. As described in FIG. 3 and FIG. 4, these exclusive control processing programs 35 and 45 are for performing exclusive control of access to the disk apparatus 2 in file units.

The disk apparatus 2 is a shared disk apparatus comprised of the disk controller and the hard disk unit (HDD). This disk apparatus 2 has a management information area (hereafter called blackboard) 20 for transferring management information, and a shared transfer area 28 for reading and writing for NAS 3a and for reading and writing for NAS 3b.

In other words, in the embodiment in FIG. 1, the transfer area is separated for each system, and the first transfer area 24 stores files written by the NAS 3a and read by the NAS 3b in file units, and the second transfer area 26 stores files written by the NAS 3b and read by the NAS 3a in file units. In the embodiment of FIG. 6, however, the transfer area 28 is shared.

In the embodiment in FIG. 1, since the area is separated, file access can be performed completely independently. In the embodiment in FIG. 6, however, where the area is shared, file access cannot be performed completely independently, but can be performed by time division, and the area can be used effectively.

[Third Embodiment]

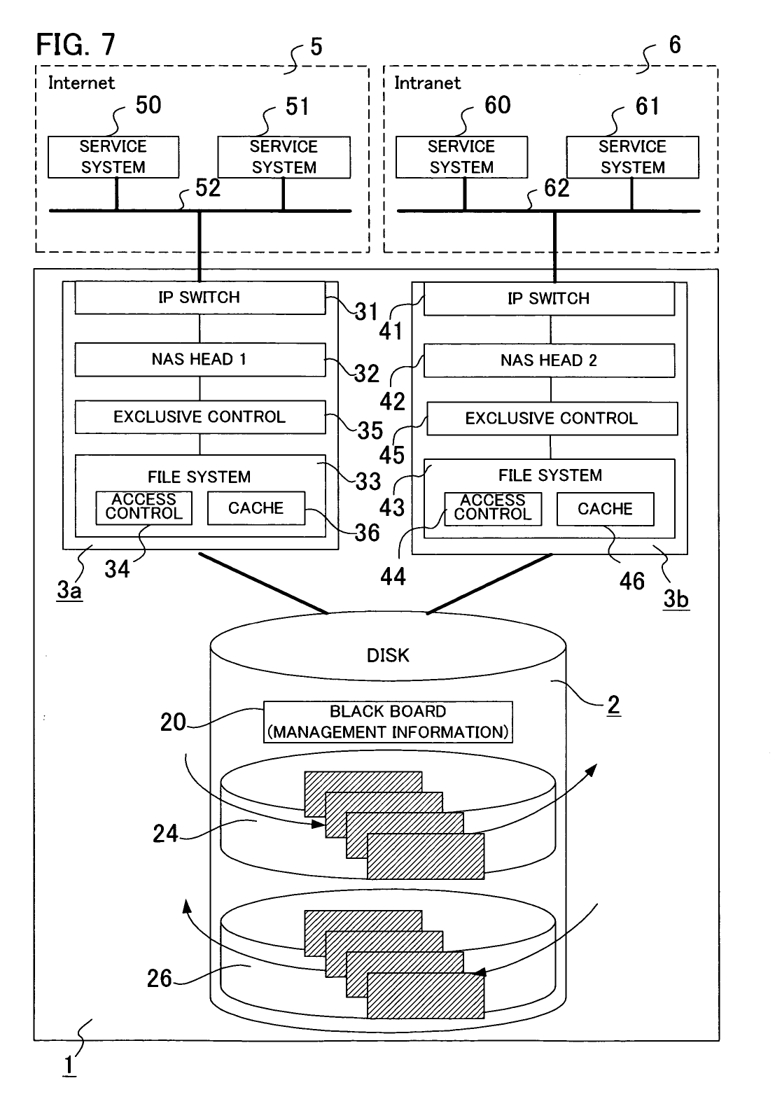

FIG. 7 is a block diagram depicting the entire inter-network relay storage apparatus of the third embodiment of the present invention. Just like FIG. 1, the network storage server (NSS) 1 is comprised of a disk apparatus (DISK) 2 and a pair of network attached servers (NAS) 3a and 3b.

The NAS 3a is connected to the Internet 5 and the NAS 3b is connected to the intranet 6. The NAS 3a and 3b are respectively comprised of the IP (Internet Protocol) switches 31 and 34, the NAS heads 32 and 42, and the file systems (programs) 33 and 43. The IP switches 31 and 41 are switches for physically connecting the network 52 of the Internet 5 and the network 62 of the intranet 6 respectively.

The NAS heads 32 and 42 and the file systems (programs) 33 and 43 are implemented by the program of the processor system in the server. The NAS heads 32 and 42 perform network connection and interface processing. The file systems 33 and 43 are programs for controlling the file, and perform data access processing 34 and 44 using the cache memories 36 and 46.

In the present embodiment, the exclusive control processing programs 35 and 45, for performing exclusive control of this data access processing, are disposed in the higher layer of the file systems 33 and 43. These exclusive control processing programs 35 and 45 are for performing exclusive control of access to the disk apparatus 2 in later mentioned file units, which was described in FIG. 3 and FIG. 4.

The disk apparatus 2 is a shared disk apparatus comprised of a disk controller and a hard disk unit (HDD). In this disk apparatus 2, a management information area (hereafter called blackboard) 20 for transferring management information, a first transfer area 24 for writing of the NAS 3a and reading of the NAS 3b, and a second transfer area 26 for writing of the NAS 3b and reading of the NAS 3a are disposed.

Just like FIG. 2, the blackboard 20 is comprised of a file use control table 21 and a file management table 23. The file use control table 21 indicates a file system which is using each file to be transferred, and is set to lock (“1”) if in use, and to unlock (“0”) if not in use.

The file management table 23 stores the area in use and the capacity of each file to be transferred. The first transfer area 24 stores the files written by the NAS 3a and read by the NAS 3b in file units. The second transfer area 26 stores the files written by the NAS 3b and read by the NAS 3a in file units.

In FIG. 7, the Internet 5 has a plurality of service systems 50 and 51 connected to the Internet network 52. The intranet 6 has a plurality of service systems 60 and 61 connected to the intranet 62. Each service system 50, 51, 60 and 61 includes a service server.

As FIG. 7 shows, by including this exclusive control mechanism in the higher layer of the file system, the service application program of the service systems 50 and 60 of the independent network can share the disk apparatus 2 and transfer data asynchronously with other service systems using such a general purpose file system as UFS (Unix File System).

In other words, as the service systems are not connected to the network, it is possible to insure safety in terms of security and also operate data distribution processing equivalent to the case of a network connection. Also as FIG. 1 shows, by including the exclusive control mechanism in the NAS, data can be transferred between service systems beyond the network, even if a plurality of service systems exist in one network, just like the case of FIG. 1.

[Fourth Embodiment]

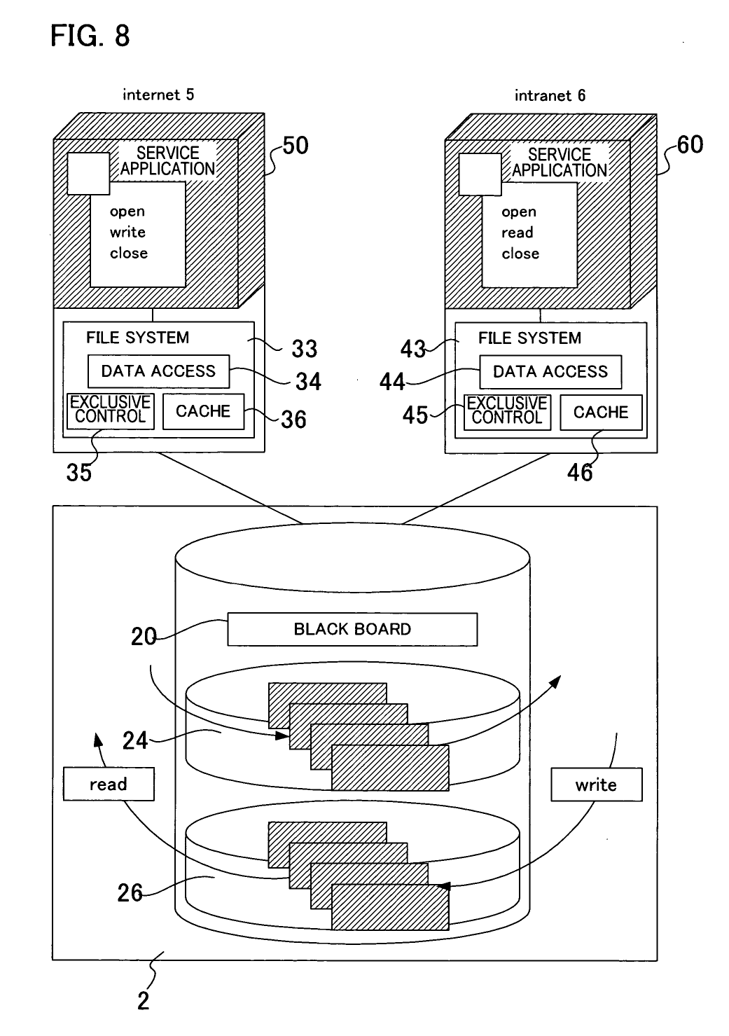

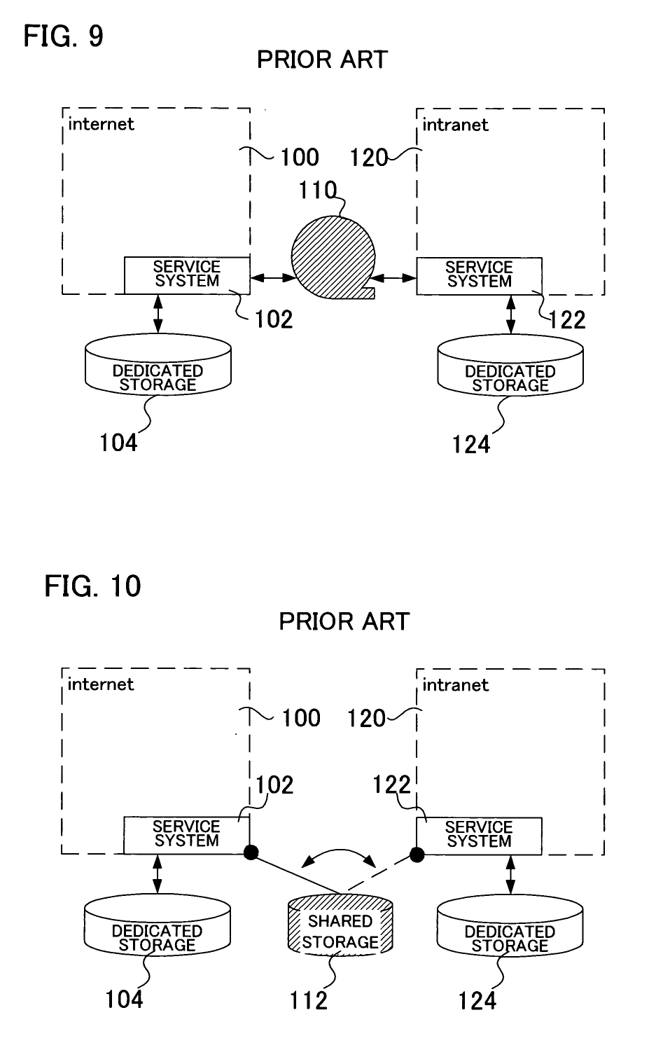

FIG. 8 is a block diagram depicting the entire inter-network relay storage apparatus of the fourth embodiment of the present invention. In this embodiment, the above mentioned file system is disposed in the servers 50 and 60 on the net, where the pair of network attached servers (NAS) 3a and 3b are omitted.

In other words, the server 50 is connected to the Internet 5 and the server 60 is connected to the intranet 6. Each one of the servers 50 and 60 executes the service application program and has file systems (programs 33 and 43). The file systems (programs) 33 and 43 are implemented by the program of the processor system in the server. The file system 33 and 43 are programs for controlling the file, and performs data access processing 34 and 44 using the cache memories 36 and 46.

In the present embodiment, the exclusive control processing programs 35 and 45, for performing exclusive control of this data access processing, are disposed in the higher layer of the file systems 33 and 43 or inside thereof. These exclusive control processing programs 35 and 45 are for performing exclusive control of access to the disk apparatus 2 in file units, which was described in FIG. 3 and FIG. 4.

The disk apparatus 2 is a shared disk apparatus comprised of the disk controller and the hard disk unit (HDD). This disk apparatus 2 is comprised of a management information area (hereafter called blackboard) 20 for transferring management information, a first transfer area 24 for writing of the server 50 and reading of the server 60, and a second transfer area 26 for writing of the server 60 and reading of the server 50.

Just like FIG. 2, the blackboard 20 is comprised of a file use control table 21 and a file management table 23. The file use control table 21 indicates a file system which is using each file to be transferred, and is set to lock (“1”) if in use, and to unlock (“0”) if not in use.

The file management table 23 stores the area in use and the capacity of each file to be transferred. The first transfer area 24 stores files written by the file system 33 of the server 50, and read by the file system 43 of the server 60 in file units. The second transfer area 26 stores files written by the file system 43 of the server 60, and read by the file system 33 of the server 50 in file units.

The Internet 5 has a service system 50 connected to the Internet network 52, and the intranet 6, which is independent from the Internet 5 has a service system 60 connected to the intranet 62. Each service system 50 and 60 includes the service server as mentioned above.

As FIG. 8 shows, by including this exclusive control mechanism inside the file system of the server or in the higher layer thereof, the service application of the service systems 50 and 60 of the independent network can share the disk apparatus 2 and transfer data asynchronously with other service systems.

In other words, as the service systems are not connected to the network, it is possible to insure safety in terms of security and also operate data distribution processing equivalent to the case of a network connection.

[Other Embodiments]

In the above embodiments a write through method, where the file system program uses cache memory and clears the cache memory after processing, was used for description, but a cache less write through method, where the disk apparatus is directly accessed without using the cache memory, can also be used. In the same way, a write through method, where a cache memory is used only for reading and a cache memory is not used for writing, can also be applied.

For the storage apparatus, a disk apparatus using a HDD was used for description, but the present invention can also be applied to a storage apparatus using other memory apparatus. The plurality of networks was described as an Internet and an intranet, but the present invention can be applied to data transfer between intranets.

As described above, data relay between separated networks is executed by exclusive control in the storage apparatus, so data can be distributed easily while insuring safety in terms of security between separated networks. Therefore by installing the storage apparatus, a data distribution processing equivalent to the case of a network connection can be possible for each service system of an individual network.

Also exclusive control is performed in file units, so operation between networks becomes easy while insuring the certainty of data distribution. For example, while writing a file, another file can be read.

What is claimed is:

1. An inter-network relay storage apparatus for distributing data between a plurality of independent network environments, comprising:
a storage unit having a data area for storing files to be transferred between said networks in file units and a file management table to indicate the access status to said file; and
a data management unit for performing exclusive control between file systems for each one of said networks using said file management table.

2. The inter-network relay storage apparatus according to claim 1, wherein said data management unit is disposed in a pair of network servers which are connected to said networks respectively.

3. The inter-network relay storage apparatus according to claim 1, further comprising a pair of network connection servers having said data management unit respectively, and are connected to said networks respectively, and communicate data via said networks.

4. The inter-network relay storage apparatus according to claim 1, wherein, when said file of said storage apparatus is read or written, said data management unit sets an indication to show that the file is in use in said file management table before said file is read or written, and resets said in use indication and performs exclusive control after said file is read or written.

5. The inter-network relay storage apparatus according to claim 4, wherein said data area of said storage unit comprises:
a first area which is written by one file system of said plurality of file systems and read by another file system; and
a second area which is written by said other file system and read by said one file system.

6. The inter-network relay storage apparatus according to claim 3, wherein said network connection server comprises:
a network control section for connecting with said network for communication; and
said data management unit.

7. An inter-network relay method for distributing data between a plurality of independent network environments, comprising the steps of:
performing the exclusive control between file systems using a file management table to indicate the access status to a file in the storage apparatus by said file system for said network; and
writing and reading files in file units to/from said storage apparatus during exclusive control, and relaying data between said networks by said file system for said network.

8. The inter-network relay method according to claim 7, wherein said file system is disposed in a pair of network servers which are connected to said networks respectively.

9. The inter-network relay method according to claim 7, further comprising a step of connecting to said networks respectively by a pair of network connection servers, and executing said data relay in file units according to the request from said networks.

10. The inter-network relay method according to claim 7, wherein said exclusive control step is a step of performing the exclusive control, when said file of said storage apparatus is read or written, by setting an indication to show the file to in use in said file management table before said file is read or written, and resetting said in use indication after said file is read or written.

11. The inter-network relay method according to claim 10, wherein said data relay step comprises:
a step of writing a first area of said storage apparatus by one file system of said plurality of file systems and reading said first area by another file system; and
a step of writing a second area of said storage apparatus by said another file and reading said second area by said one file system.

12. The inter-network relay method according to claim 9, wherein further comprises a step of issuing a data relay request to the network connection server connected to said network by said service system of said network.
